(19) United States
(12) Patent Application Publication
(10) Pub. No.: US 2026/0139706 A1
(43) Pub. Date: May 21, 2026

(54) Locking Suction Mount

(71) Applicant: House of Atlas, LLC, Evanston, IL (US)

(72) Inventors: Jason Moss, Libertyville, IL (US); William Paxton, Evanston, IL (US)

(21) Appl. No.: 18/949,463

(22) Filed: Nov. 15, 2024

(51) Int. Cl. F16B 47/00; F16M 13/02

(52) U.S. Cl. CPC F16B 47/006; F16M 13/022

(57) ABSTRACT

A suction mount is provided. The suction mount includes a housing, a suction cup positioned at a first side of the housing, a lever mechanically coupled to the suction cup and positioned at least in part within the housing, and a lock couplable to the lever. The lever is moveable relative to the housing between a first position corresponding to an unactuated state of the suction cup and a second position relative to the housing corresponding to an actuated state of the suction cup. The lock is couplable to the lever such that that lever is prohibited from moving away from the second position while the suction cup is in the actuated state.

### FIELD

This disclosure relates to suction cup mounts, and, more particularly, to mountable locking suction cups.

### BACKGROUND

Wall mountable accessories are commonly used in homes to hold kitchen or bathroom accessories. For example, often hooks are designed to be secured to a wall by screws fitted in a base of the hook. However, this method of mounting may not be convenient or appropriate when working with a tiled wall surface, since drilling may cause damage to the tile.

Suction cup mounts are useful and convenient to use on tiled or other high gloss surfaces, since they can be removed and replaced as often as desired without causing damage to the mounting surface. These devices operate by creating a vacuum between the suction cup and the adhering surface. However, many suction cup mechanisms are prone to loss of vacuum over time. This can occur, for instance, if the vacuum is not securely locked in place once it is created or if the suction mechanism is prematurely or inadvertently released.

There is a need for a suction cup mount that achieves secure and strong suction, does not prematurely release, and has a simple design.

### BRIEF DESCRIPTION OF THE DRAWINGS

FIG. 1 is a front-side perspective view of a suction mount according to an embodiment, in an actuated state of the suction mount.

FIG. 2 is a front-side perspective view of the suction mount of FIG. 1, in an unactuated state of the suction mount.

FIG. 3 is an exploded view of the suction mount of FIG. 1.

FIG. 4 is a cross-sectional view of the suction mount of FIG. 1 in an unactuated state of the suction mount taken along line 4-4 of FIG. 2.

FIG. 5 is a cross-sectional view of the suction mount of FIG. 1 in an actuated state of the suction mount taken along line 5-5 of FIG. 1.

FIG. 6 is a top plan view of a base assembly of the suction mount of FIG. 1.

FIG. 7 is a bottom plan view of the base assembly of FIG. 6.

FIG. 8 is a top plan view of a base of the suction mount of FIG. 1.

FIG. 9 is a rear-side perspective view of the base of FIG. 8.

FIG. 10 is a front-side perspective view of the base of FIG. 8.

FIG. 11 is an enlarged partial cross-sectional view of the base of FIG. 8 taken along line 11-11 of FIG. 8.

FIG. 12A is a top perspective view of a post of the suction mount of FIG. 1.

FIG. 12B is a bottom perspective view of the post of FIG. 12A.

FIG. 13 is a top perspective view of a suction cup of the suction mount of FIG. 1.

FIG. 14A is a front-side perspective view of a lever of the suction mount of FIG. 1.

FIG. 14B is a rear-side perspective view of the lever of FIG. 14A.

FIG. 14C is a side elevational view of the lever of FIG. 14A.

FIG. 14D is a bottom perspective view of the lever of FIG. 14A.

FIG. 14E is a top plan view of the lever of FIG. 14A.

FIG. 15A is a bottom perspective view of a lock body of the suction mount of FIG. 1.

FIG. 15B is a top perspective view of the lock body of FIG. 15A.

FIG. 15C is another bottom perspective view of the lock body of FIG. 15A.

FIG. 15D is a cross-sectional view of the lock body of FIG. 15A taken along line 15D-15D of FIG. 15B.

### DETAILED DESCRIPTION

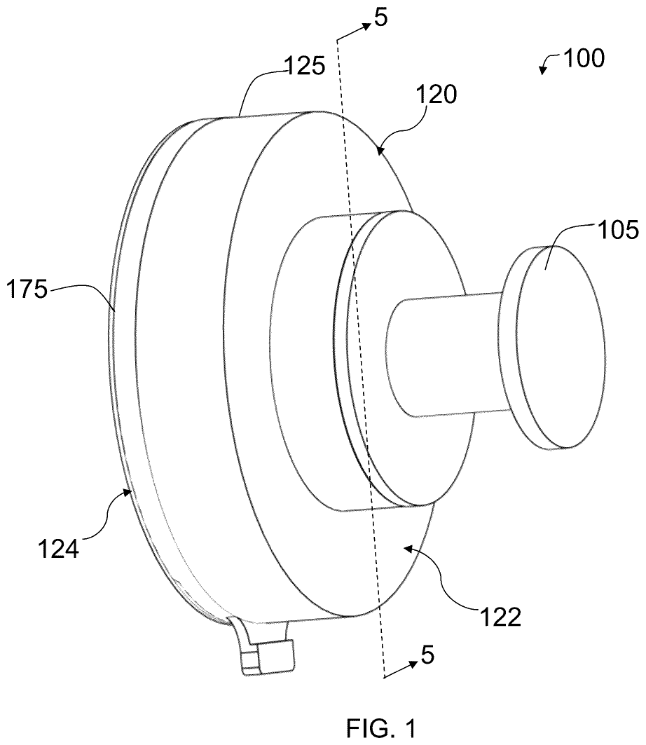

With reference to FIGS. 1-5, there is illustrated a suction mount 100 that may be mounted to a wall or other surface to hold items. Advantageously, the suction mount 100 is lockable to prevent premature release of the suction so that the suction mount 100 maintains a firm and secure connection to the mounting surface during use. More specifically, the suction mount 100 includes a lock body 105 or hook body that is coupled to the suction mount 100 to lock the suction mechanism in an actuated state. Thus, the lock body 105 has a dual purpose of locking the suction mechanism while also serving as a hook for hanging items (or other useful accessory, in other embodiments). The suction mount 100 is also easy to use and has a simple and aesthetically pleasing design.

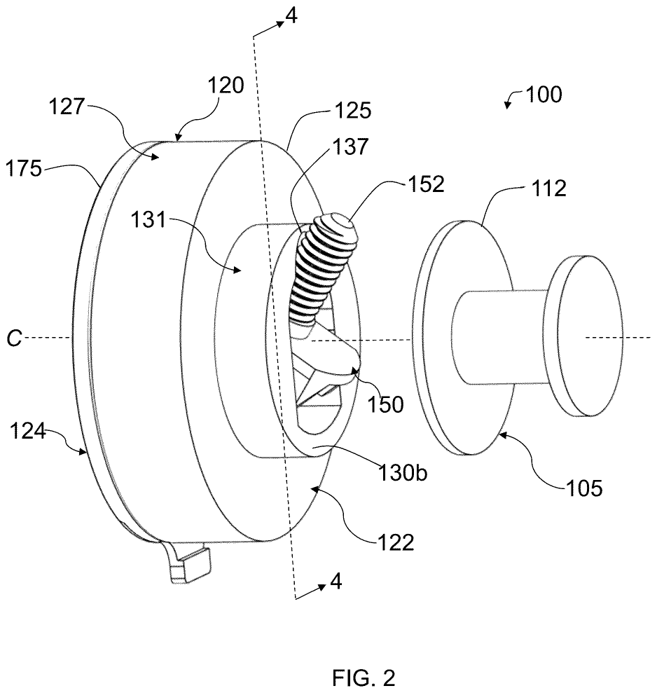

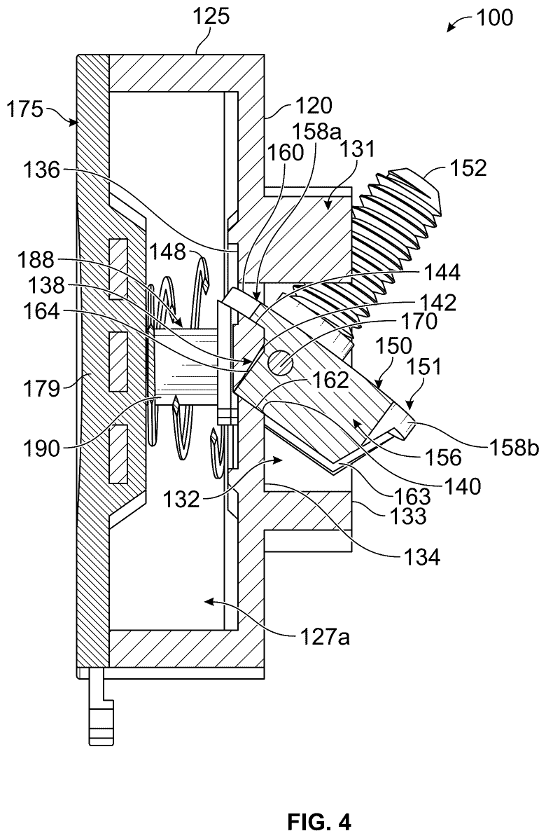

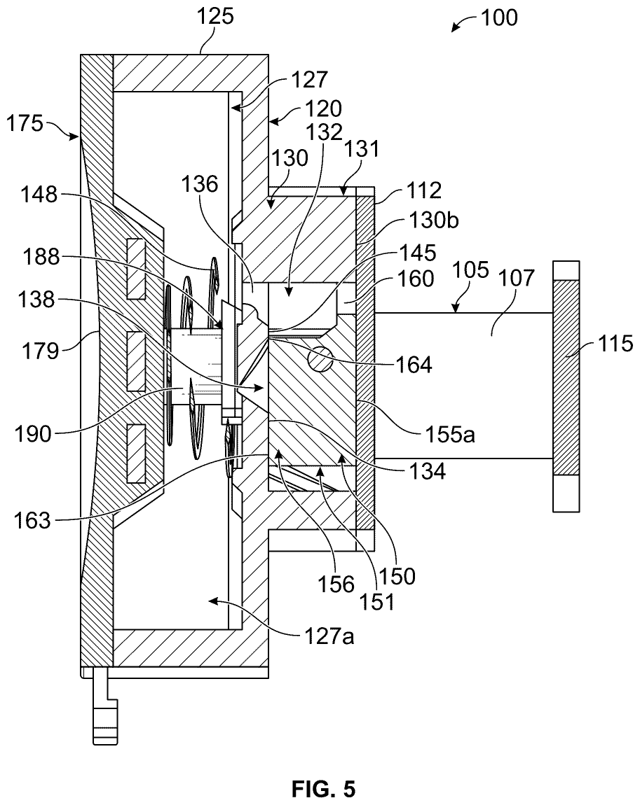

The suction mount 100 includes a base assembly 120 and the lock body 105. The lock body 105 can be attached to the base assembly 120 when the suction mount 100 is mounted to a mounting surface to lock the suction mechanism in the actuated state. FIGS. 1 and 5 show the suction mount 100 in an actuated and locked state of the suction mount 100, with the lock body 105 attached to the base assembly 120. Specifically, the lock body 105 is removably coupled to an actuation lever 150 of the base assembly 120 and prevents the lever 150 from moving out of an actuated position of the lever 150. FIGS. 2 and 4, on the other hand, show the suction mount 100 in an unactuated and unlocked state of the suction mount 100, with the lock body 105 detached from the base assembly 120, and the lever 150 in an unactuated position.

With reference to FIGS. 2-4, 6, and 7, the base assembly 120 includes a base 125 or housing, a suction cup assembly 188 having a suction cup 175 or flexible diaphragm and a central post 190, a spring 148 or other biasing element positioned between the base 125 and the suction cup 175 biasing the suction cup 175 in an unactuated position, and the lever 150. The lever 150 is pivotably coupled to the central post 190 of the suction cup assembly 188 to move the suction cup assembly 188 between the actuated state and the unactuated state. The base assembly 120 has a first, mounting side 124 containing the suction cup 175 for attaching to a mounting surface and a second, front or top side 122 opposite the first side 124 that provides access to the lever 150 to actuate or de-actuate the suction and receives the lock body 105 to lock the lever 150 and hang items.

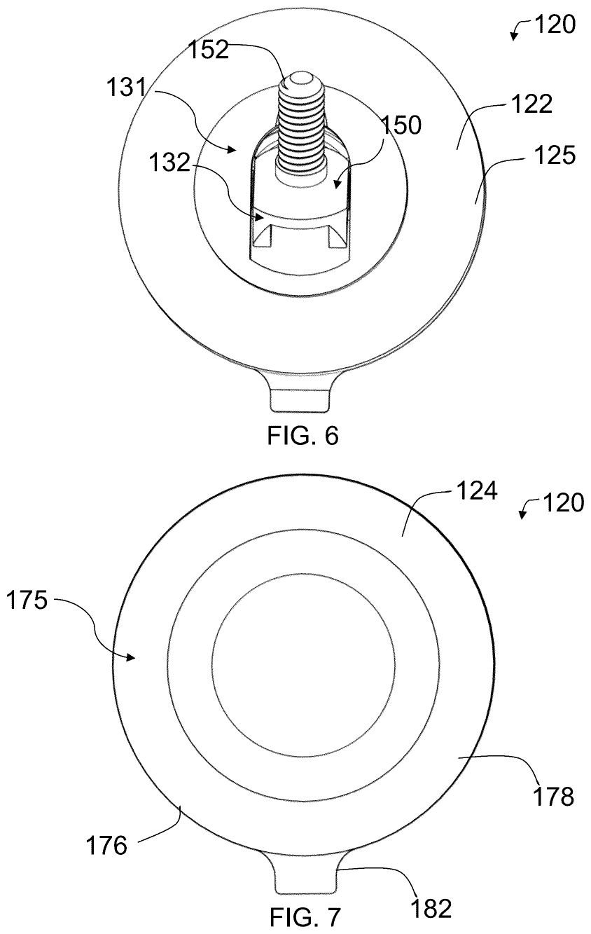

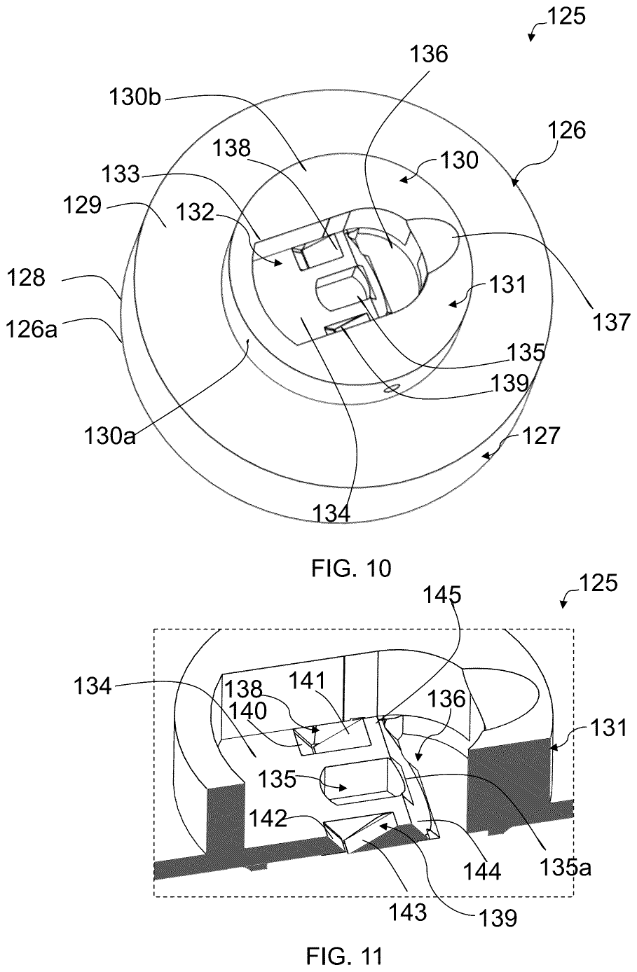

With reference to FIGS. 6-11, the base 125 has a generally circular profile and is sized to correspond to the generally circular suction cup 175. The suction cup 175 is coupled to the mounting side 124 of the base 125. As shown, perimeters of the base 125 and the suction cup 175 may generally align when the suction cup 175 is attached to the base. In some approaches, the base 125 is a molded plastic component (e.g., a rigid plastic).

More specifically, the base 125 defines a first compartment 127 and a second compartment 131. The first compartment 127 provides space for the suction cup 175 to generate a vacuum while the second compartment 131 houses the lever 150. The first compartment 127 is formed by an annular side wall 126a, a lateral wall 129 substantially perpendicular to the annular side wall 126a and defining a bottom to the compartment 127, and a first cavity 127a defined between the annular side wall 126a and the lateral wall 129. The annular side wall 126a includes a terminal face 126b at an open end 128 of the first compartment 127 opposite the lateral wall 129 that engages a peripheral portion 178 of the suction cup 175. In some approaches, the suction cup 175 is not attached to the terminal face 126b, while in other approaches the suction cup 175 is attached to the terminal face 126b. In some embodiments, the suction cup 175 contacts or engages the terminal face 126b in both the unactuated and actuated state of the suction cup even if the suction cup 175 is not attached to the terminal face 126b.

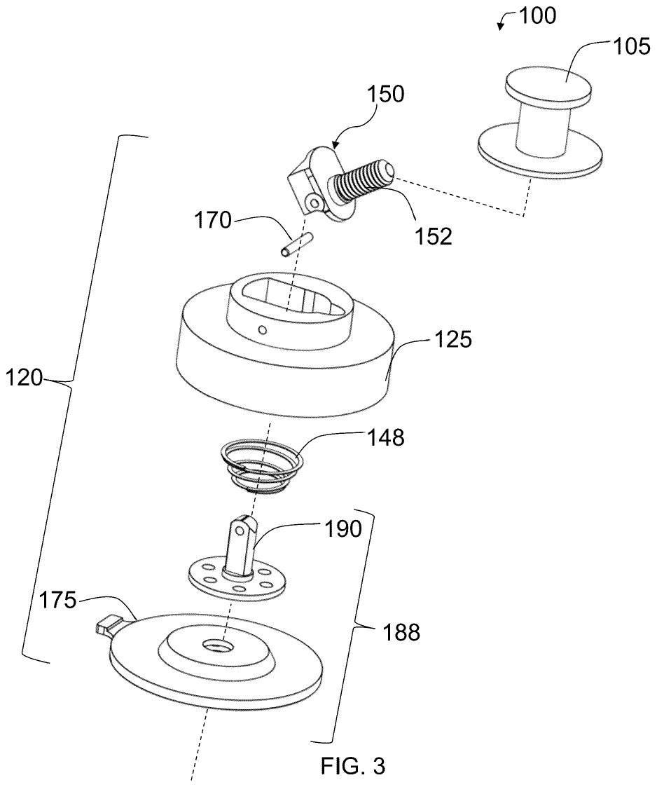

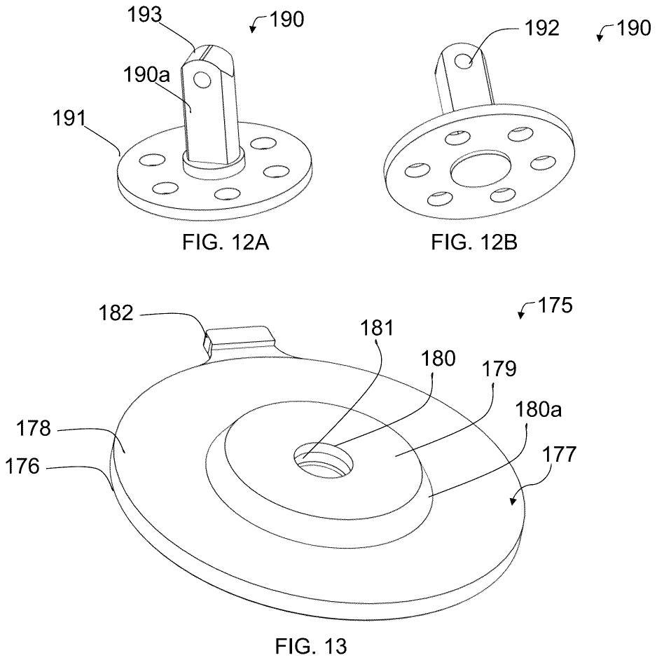

With reference to FIGS. 3, 4 and 12A-13, the suction cup 175 is generally planar with a first or outer side 176 that attaches to the mounting surface and a second or inner side 177 opposite the first side 176 that faces the base 125. In some approaches, a tab 182 extends radially outwardly from the main perimeter of the suction cup 175 to facilitate peeling the suction cup off the wall. A central portion 179 of the suction cup 175 includes a central hole 180 or recess in the second side 177 of the suction cup 175 that receives the post 190. In some approaches, the central portion 179 includes a central projection 180a projecting from the second side 177 of the suction cup 175 and the central hole 180 is defined in the central projection 180a. In some approaches, the central projection 180a includes an annular slot 181 extending radially from the hole 180 within the central projection 180a for a base 191 of the post 190.

The post 190 has an elongated body 190a and a planar base 191. The elongated body 190a may project centrally from the base 19a. In embodiments, the post 190 is a rigid plastic component that is attached to the suction cup 175 during a molding process of the suction cup 175. More specifically, the base 191 may be molded into the suction cup thereby forming the annular slot 181 of the central projection 180a of the suction cup 175, with the elongated body 190a of the post 190 extending axially through the hole 180 of the suction cup 175. In embodiments, a distal end 193 of the post 190 includes a hole 192 for receiving a pivot pin 170 (FIG. 3) to pivotably couple the lever 150 to the post 190. The distal end 193 of the post 190 may be disposed in part in a bottom cavity 165 of the lever 150 and may have an arcuate shape to facilitate pivoting of the lever 150 about the post 190.

The post 190 extends axially through the first cavity 127a of the first compartment 127, through a passage 135 formed in the lateral wall 129, and into the second compartment 131, described further below. A spring 148 (e.g., a helical compression spring) or other biasing element is disposed in the first compartment 127 about the post 190, engaging an inner surface 129a of the lateral wall 129 (FIG. 9) and the central portion 179 of the suction cup 175. The spring 148 applies force to the suction cup 175 to bias the central portion 179 of the suction cup 175 away from the base 125 to an unactuated state. In some approaches, as shown in FIG. 9, an annular ridge 149 projects from the inner surface 129a of the lateral wall 129 to register and/or retain the spring 148 in a generally axial position. In some approaches, the ends of the spring 148 are fixed to the lateral wall 129 and/or the suction cup 175.

With reference to FIGS. 2, 6 and 8-11, the second compartment 131 of the base 125 projects from an outer surface 129b of the lateral wall 129. More specifically, the second compartment 131 is formed in part by a central projection 130 positioned generally along central longitudinal axis C of the suction mount 100 and a second cavity 132 or recess defined in the central projection 130. In some approaches, a radially-facing side surface 130a of the central projection 130 has a circular shape and is coaxial with the annular side wall 126a of the base 125. The second cavity 132, on the other hand, may have an elongated shape as illustrated to conform to an elongated shape of the lever 150. As shown, the second compartment 131 may have a smaller diameter than the first compartment 127.

The central projection 130 also defines an axially-facing flat surface 130b surrounding the second cavity 132. As explained further below, the flat surface 130b of the second compartment 131 is engaged by a planar flange 112 of the lock body 105 to lock the lever 150 in the actuated position.

The second cavity 132 has an open end 133 and a bottom surface 134, which may be defined by the lateral wall 129 of the base 125. In some approaches, the second cavity 132 has an elongated shape such as a rectangular, oval, or rounded rectangular shape. For instance, as illustrated, the second cavity 132 has a first rounded side 147a that is generally opposite to a second rounded side 147b, and a third linear side 147c that is generally opposite to a fourth linear side 147d. The third and fourth sides 147c, 147d, in some embodiments, are longer than the first and second sides 147a, 147b to permit pivoting of the lever 150 along a central longitudinal axis y of the second cavity 132. As shown, the third and fourth sides 147c, 147d may curve to form the first rounded side 147a. An arcuate recess is defined in the flat surface 130b adjacent the first side 147a of the second cavity 132 for receiving a portion of the lever 150 when the lever 150 is in the unactuated position (see FIG. 4).

As noted above, a central passage 135 extends through the lateral wall 129 from the first compartment 127 to the second compartment 131. The distal end 193 of the post 190 (FIG. 12A) extends through the central passage 135 into the second cavity 132. The central passage 135 is positioned along the central longitudinal axis y of the second cavity 132 and along the central longitudinal axis C of the suction mount 100. The second cavity 132 also includes a hole 136 extending through the lateral wall 129 adjacent the first side 147a of the second cavity. The hole 136 is sized and positioned to receive a portion of the lever 150 when the lever 150 is in the unactuated position (see FIG. 4), as explained further below. In some approaches, an angled surface 144 extending between the central passage 135 and the hole 136 defines a side of the hole 136 that a portion of the lever 150 rests upon when the lever 150 is received in the hole 136.

As illustrated, the hole 136 may extend substantially an entire width of the second cavity 132 (between the third side 147c and the fourth side 147d) and through the lateral wall 129 from the second cavity 132 to the first cavity 127a. The hole 136 may have a curvature that conforms to a curvature of the first side 147a.

The second compartment 131 also includes a first cut-out 138 and a second cut-out 139 in the bottom surface 134 of the second cavity 132. The first cut-out 138 and second cut-out 139 are arranged on opposite sides of the central passage 135 (adjacent the third and fourth sides 147c, 147d, respectively, of the second cavity 132) and generally in a row with the central passage 135. Each cut-out 138, 139 is shaped to contain a portion of lever 150 in the unactuated position and to guide the lever 150 when the lever is being pivoted to the actuated position, as described further below.

More specifically, the first cut-out 138 has a generally triangular cross-section (FIG. 11) defined by a first inclined surface 140 and a second inclined surface 141 extending downwardly from the bottom surface 134 of the second cavity 132 and meeting at a vertex. The width of the cut-out 138 and an angle defined between the first and second inclined surfaces 140, 141, in some approaches, corresponds to shape of the lever 150 so that a portion of the lever 150 seats in the cut-out 138 in the unactuated position. In some embodiments, the angle is about 90 degrees. In some approaches, the angle may be slightly greater than or less than 90 degrees. In some approaches, the second inclined surface 141 is longer than the first inclined surface 140. As described further below, the second inclined surface 141 is sized and positioned to wedge or hoist the lever 150 out of the first cut-out 138 when the lever 150 is pivoted from the unactuated position to the actuated position.

In some approaches, the second cut-out 139 is the same as the first cut-out 138, having a third inclined surface 142 and fourth inclined surface 143 that correspond to the first inclined surface 140 and the second inclined surface 141. The first cut-out 138 and the second cut-out 139 simultaneously engage different portions of the lever 150 while the lever 150 is pivoted from the unactuated position to the actuated position to provide force to lift the suction cup 175 to create suction for mounting the base assembly 120 to a surface.

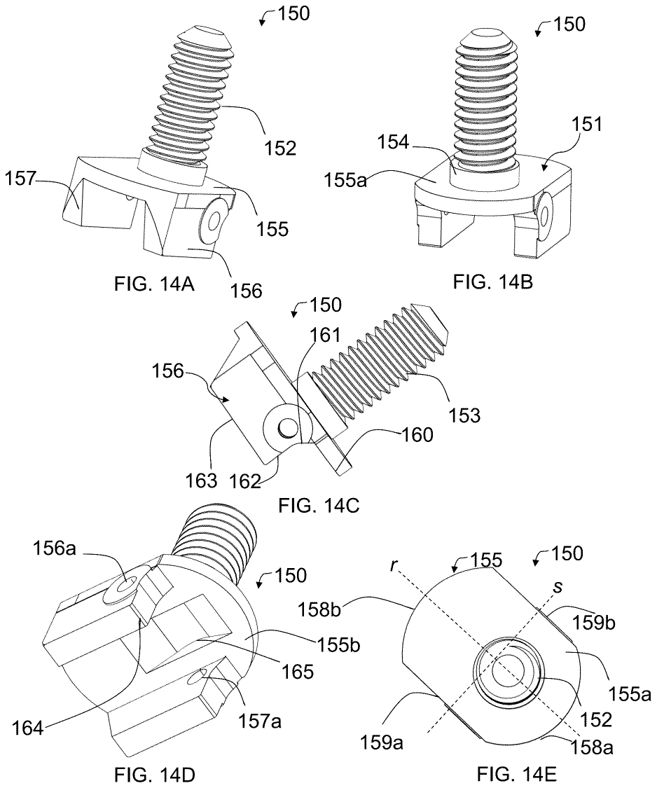

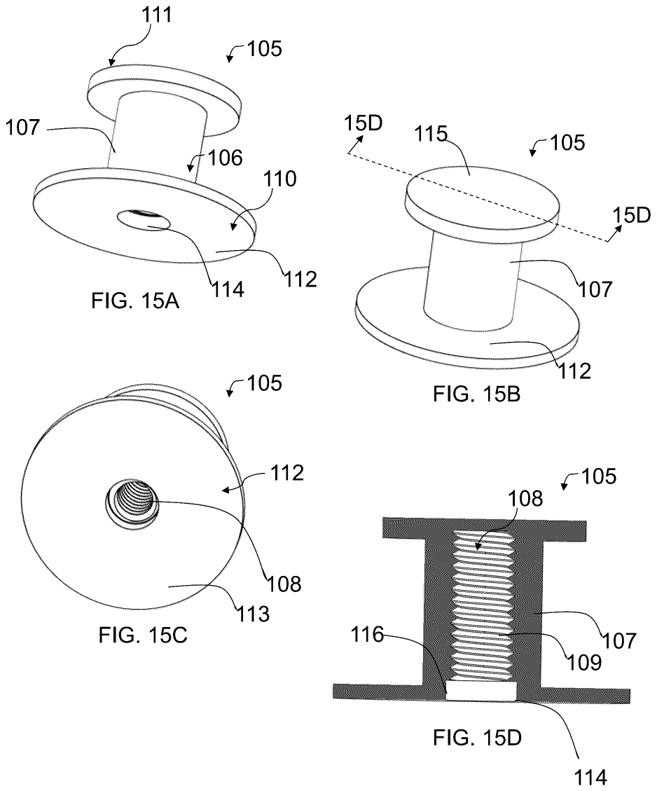

With reference to FIGS. 4 and 14A-14E, the lever 150 includes a base 151 and an elongated lever arm 152 projecting substantially perpendicularly from the base 151. The base 151 is pivotably coupled to the post 190 via the rod 170. In some approaches, the rod 170 extends through two holes 156a, 157a of a yoke of the base 151. In the base assembly 120, the lever arm 152 extends at least partially out of the open end 133 of the second compartment 131 so that the lever arm 152 is accessible to the user during use of the suction mount 100. More specifically, the user grasps the lever arm 152 to move the lever 150 between the unactuated position and the actuated position. In a non-limiting embodiment, the lever arm 152 may be a threaded shaft that includes external threading 153 (e.g., continuous or discontinuous threading) for mating with internal threading 109 (FIG. 15D) of the lock body 105 when the lock body 105 is threaded onto the lever arm 152 to lock the lever 150 in the actuated position. In other approaches, the lever arm 152 couples to the lock body 105 in different manners such as snap fit or friction fit.

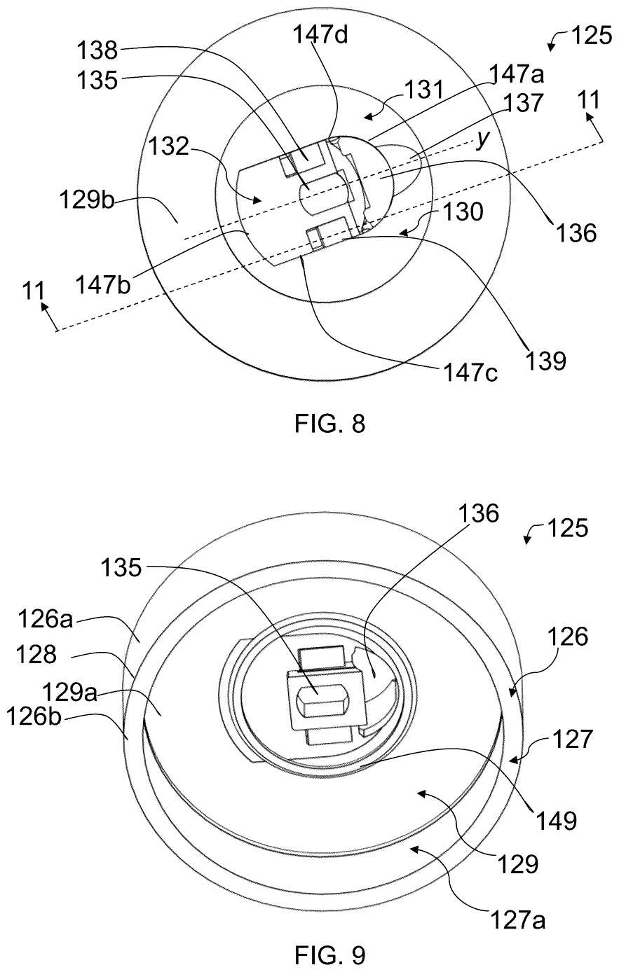

The base 151 of the lever 150 is formed by a lateral wall 155 with a top surface 155a and a bottom surface 155b. The top and bottom surfaces 1551, 155b may be flat. The lever arm 152 projects from the top surface 155a and a first flange 156 and a second flange 157 project downwardly from the bottom surface 155b to form the yoke. The lateral wall 155 may define an elongated shape of the lever 150 that pivots within the elongated second cavity 132 of the base assembly 120 along the central longitudinal axis y of the second cavity 132 (FIG. 8). For instance, as illustrated, the lateral wall 155 may include a first end 158a, a second end 158b opposite the first end 158a, and first and second opposing sides 159a, 159b extending between the first end 158a and the second end 158b. A width of the lateral wall 155 between the first and second sides 159a, 159b may be shorter than a length of the lateral wall 155 between the first and second ends 158a, 158b. More specifically, the width of the lateral wall 155 may be sized only slightly smaller than a corresponding width of the second cavity 132. As shown, in some embodiments, the first and second ends 158a, 158b may have a curved profile, and the first and second sides 159a, 159b may be linear.

In some approaches, the lever arm 152 is positioned along a longitudinal centerline r of the lateral wall 155 but is not positioned along a latitudinal centerline s of the lateral wall 155. Instead, the lever arm 152 is spaced from the latitudinal centerline s to define an asymmetry of the lever 150 such that the base 151 is longer on one side of the lever arm 152 (adjacent the second end 158b) than the other side (adjacent the first end 158a).

The flanges 156, 157 extend downwardly, respectively, from the bottom surface 155b at the first and second sides 159a, 159b on opposing sides of the lever arm 152. The flanges 156, 157, in some embodiments, are identical to one another, and may have a length extending all the way to the second end 158b. In some approaches, the flanges 156, 157 stop short of extending beyond the lever arm 152 to the first end 148a, defining a planar first end portion 160 of the base 151.

The flanges 156, 157 includes the two holes 156a, 157a for supporting the pivot rod 170. The two holes 156a, 157a are positioned on the flanges 156, 157 on opposite sides of the lever arm 152 so that the rod 170 extends between the holes 156a, 157a directly under the lever arm 152. The distal end 193 of the post 190 of the suction cup assembly 188 is positioned in the space between the two flanges 156, 157 so that the rod 170 extends through the hole 192 of the post 190, pivotably coupling the lever 150 to the post 190 (FIGS. 12A and 12B). The bottom surface 155b of the lateral wall 155 may include an angled or arcuate cutout 165, as noted above, to provide clearance for the lever 150 to pivot about the post 190.

While the flanges 156, 157 may have a generally rectangular shape, the flanges 156, 157 also include a plurality of surfaces configured to engage the respective cut-outs 138, 139 of the base assembly 120 to move the lever 150 between the unactuated position and the actuated position. More specifically, the first flange 156, for instance, includes a flat bottom face 163 that is substantially parallel to the lateral wall 155 and a flat side surface 162 adjacent the pivot hole 156a that is substantially perpendicular to the bottom face 163. The bottom face 163 and the side surface 162 define a corner or edge 164 of the flange 156 therebetween. A chamfer or arcuate surface 161 extends adjacent the pivot hole 156a from the side surface 162 to the planar first end portion 160 of the base 151. While the flange surfaces are only specifically described herein for the first flange 156, it will be appreciated that the second flange 157 has the same configuration. Further, the way these surfaces specifically engage the cut-outs 138, 139 of the base assembly 120 will be detailed further below.

With reference to FIGS. 15A-15D, the lock body 105 has a body 106 that may take the shape of a hook or a knob for hanging items. The lock body 105 may be a plastic or metal component. The lock body 105 includes a cylindrical stem 107 or sleeve, a first flange 112, and a second flange 115. A cavity 108 is defined in the stem 107 with internal threading 109 disposed along a substantial length of the cavity 108. The cavity is open at a first end 110 of the lock body 105 and closed at a second end 111 of the lock body 105. The lock body 105 threadingly engages the lever arm 152 of the lever 150 to lock the lever 150 in the actuated position and, in embodiments, to serve as a hook. In some approaches, there may be a non-threaded portion 116 of the cavity 108 adjacent the first end 110 and outboard of the threading 109. The non-threaded portion 116 may be sized and positioned to receive a corresponding non-threaded portion 154 of the lever arm 152 adjacent the base 151 of the lever 150 (FIG. 14B).

In other embodiments, the lever arm 152 and the lock body 105 do not include threading and instead include a different manner of coupling (e.g., snap fit, friction fit, etc.). When there is threading, the threading may be continuous or discontinuous threading.

The first and second flanges 112, 115 may be circular flanges that are arranged co-axially with the stem 107 at opposite sides thereof. For instance, the first flange 112 may be positioned at the first end 110 of the lock body 105, and the second flange 115 may be positioned at the second end 111 of the lock body 105. The first and second flanges 112, 115 have larger diameters than the stem 107. The second flange 115 extends radially outward from the stem 107 to retain any items hung on the stem 107 when the suction mount 100 is mounted. In some approaches, the first flange 112 has a larger diameter than the second flange 115. The first flange 112 defines a flat annular face 113 that extends radially outwardly from an opening 114 to the cavity 108. The annular face 113 is sized and positioned to engage the flat surface 130b of the central projection 130 surrounding the second cavity 132 of the base assembly 120 to lock the lever 150 in the actuated position. In some approaches, the first flange 112 has the same diameter as the central projection 130 so that the components are substantially flush when the lock body 105 is attached to the base assembly 120, as shown in FIGS. 1 and 5.

In some embodiments, instead of the first flange 112, the first end 110 of the lock body 105 may define a different structure for hanging items. For instance, the first end 110 may extend into a curved hook or may extend into a ring for holding towels. The first end 110 may also extend into a different type of accessory, such as a tray, a basket, a razor holder, a shower foot step, etc. In some approaches, an accessory may be mounted onto the first end 110.

With reference to FIGS. 1, 2, 4, and 5, the suction mount 100 is mounted on a mounting surface such as a wall in the following manner. FIGS. 2 and 4 illustrate the suction mount 100 in an unactuated state in which suction has not been generated and the suction mount 100 is not mounted to the wall. In the unactuated state, the suction cup assembly 188 is biased by the spring 148 away from the base 125, causing the central portion 179 of the suction cup 175 to be nearly level with the peripheral portion 178 of the suction cup 175.

In the unactuated state, the lock body 105 is not attached to the base assembly 120. The biased suction cup assembly 118, which is attached to the lever 150 via the post 190, biases the lever 150 in an unactuated position of the lever 150. In the unactuated position, the flanges 156, 157 of the lever 150 are positioned in the respective cut-outs 138, 139 of the second compartment 131, and the lever arm 152 is in an angled position with respect to the central longitudinal axis C. Specifically, a distal end of the lever arm 152 may be positioned in the arcuate recess 137 in the surface 130b of the central projection 130. In the unactuated position, the first end portion 160 of the lever base 151 is positioned in the hole 136 below the bottom surface 134 of the second cavity 132, while the second end 158b of the lever base 151 is raised relative to the bottom surface 134.

More specifically, in the unactuated position, the first flange 156 of the lever base 151 is positioned in the first cut-out 138 with the bottom face 163 of the first flange 156 engaging or closely engaging the first inclined surface 140 of the first cut-out 138, the side surface 162 of the first flange 156 engaging or closely engaging the second inclined surface 141 of the first cut-out 138, and the corner 164 of the first flange 156 positioned at the vertex between the first inclined surface 140 and the second inclined surface 141 of the first cut-out 138. In addition, the chamfer 161 of the first flange 156 engages a strip 145 of the bottom surface 134 of the second cavity 132 between the first cut-out 138 and the hole 136, and the first end portion 160 engages the angled side surface 144 of the hole 136 as the first end portion 160 extends into the hole 136. In some approaches, the first end portion 160 extends partially into the first cavity 127a. The second flange 157 is positioned in the second cut-out 139 in the same manner.

To mount the suction mount 100 to the wall, a user first positions the base assembly 120 against a mounting surface and presses firmly so that the suction cup 175 is firmly pressed against the mounting surface in the unactuated state. To actuate the suction, the user then rotates the lever arm 152 out of the angled, unactuated position until the lever arm 152 extends in alignment with the central longitudinal axis C of the suction mount 100. In this position, the lever arm 152 is substantially perpendicular to the mounting surface. When the lever arm 152 is rotated into the central, actuated position, the flanges 156, 157 of the lever base 151 are simultaneously pivoted so that they are hoisted out of the respective cut-outs 138, 139. More specifically, for instance, when the second end 158b of the lever base 151 is pivoted towards the bottom surface 134 of the second cavity 132 as a result of the lever arm 152 being rotated into the central position, the corner 164 of the first flange 156 is drawn out of the vertex of the cut-out 138 and wedged up or cams along the second inclined surface 141 while the flat bottom face 163 of the first flange 156 adjacent the second end 158b moves towards the bottom surface 134. When the lever arm 152 reaches the central position, the corner 164 has been cammed up along the second inclined surface 141 and moved out of the cut-out 138 so that a leading portion of the flat bottom face 163 of the first flange 156 seats flatly on the strip 145 of the bottom surface 134 of the second cavity 132, with the rest of the flat bottom face 163 extending over the cut-out 138 and against the bottom surface 134 at the other end of the second cavity 132, as shown in FIG. 5. It will be appreciated that the second flange 157 is moved relative to the second cut-out 139 in the same manner. In the actuated position, the top surface 155a of the lever base 151 may be substantially co-linear or flush with the flat surface 130b of the central projection 130.

Moving the flanges 156, 157 of the lever 150 out of the cut-outs 138, 139 simultaneously draws the lever 150, rod 170, and post 190 axially away from the mounting surface, which likewise draws the central portion 179 of the suction cup 175 axially away from the mounting surface and farther into the first cavity 127a of the base assembly 120 against the force of the spring 148 (while the peripheral portion 178 of the suction cup 175 remains pressed by the housing against the mounting surface), thus forming a vacuum between the suction cup 175 and the mounting surface so that the base assembly 120 is suctioned against the mounting surface in the actuated state.

The user then attaches the lock body 105 to the base assembly 120, which locks the lever 150 in the actuated position to maintain the suction mount 100 in the actuated state and prevent premature release. More specifically, the user threads the lever arm 152 into the cavity 108 of the lock body 105 until the lever arm 152 is fully received in the cavity 108 and/or the flat face 113 of the second flange 115 abuts the flat surface 130b of the central projection 130. This engagement between the second flange 115 and the central projection 130 rigidly fixes the lock body 105 and the lever 150 with respect to the base assembly 120. In some approaches, the second flange 115 may also contact or come close to contacting the top surface 155a of the lever base 151. With the flat face 113 of the second flange 115 near or abutting the flat surface 130b of the central projection 130, the lever arm 152 is locked in the actuated position along the central longitudinal axis C and prevented from pivoting back to the unactuated position. Thus, the vacuum generated in the actuated state of the suction mount 100 is securely maintained.

As noted above, in the illustrated embodiment the lock body 105 not only locks the suction mechanism to prevent premature release of the suction but also serves as a hook for hanging items. As shown in FIG. 1, the lock body 105 and the base assembly 120 neatly interface to form a simple and aesthetically pleasing outer appearance when mounted on a wall, while obscuring the inner suction mechanism.

To demount the suction mount 100, the above-described operation is reversed. The user detaches the lock body 105 from the base assembly 120 to unlock the lever 150 and pivots the lever arm 152 back towards the angled, unactuated position. This action combined with the biasing of the spring 148 moves the flanges 156, 157 of the lever 150 back into the respective cut-outs 138, 139, which simultaneously moves the post 190 and the central portion 179 of the suction cup 175 back towards the mounting surface to release the vacuum.

It will be appreciated that the suction mount 100 may be arranged in any orientation on the wall besides the orientations illustrated. For instance, the suction mount 100 may be positioned so that the lever arm 152 is angled downwardly or to the side when in the unactuated position. It will also be appreciated that the suction mount 100 may function best when mounted on a smooth, non-porous mounting surface (e.g., tile, glass, hard plastic, acrylic, fiberglass, metal, etc.).

The matter set forth in the foregoing description and accompanying drawings is offered by way of example and illustration only and not as a limitation. While certain embodiments have been shown and described, it will be apparent to those skilled in the art that additions, changes, and modifications may be made without departing from the broader aspects of the technological contribution. The actual scope of the protection sought is intended to be defined in the following claims.

What is claimed is:

1. A suction mount comprising:
a housing;
a suction cup positioned at a first side of the housing;
a lever mechanically coupled to the suction cup and positioned at least in part within the housing and projecting from a second side of the housing; and
a lock couplable to the lever,
wherein the lever is moveable relative to the housing between a first position corresponding to an unactuated state of the suction cup and a second position relative to the housing corresponding to an actuated state of the suction cup, and
wherein the lock is couplable to the lever such that that lever is prohibited from moving away from the second position while the suction cup is in the actuated state.

2. The suction mount of claim 1, wherein the lock defines a cavity that receives a portion of the lever.

3. The suction mount of claim 2, wherein the lever comprises external threading that engages internal threading in the cavity of the lock.

4. The suction mount of claim 2, wherein the lock comprises a flange sized and positioned to engage a surface of the housing to lock the lever in the second position.

5. The suction mount of claim 1, wherein the lever includes a lever arm that extends at least partially out of the housing, wherein in the first position the lever arm is angled with respect to a central axis of the suction mount and in the second position the lever arm is aligned with the central axis.

6. The suction mount of claim 1, wherein the lever includes a base, a lever arm extending from a first side of the base, and a yoke extending from a second side of the base.

7. The suction mount of claim 6, wherein the yoke is received in first and second cut-outs of the housing in the first position of the lever and is moved out from the first and second cut-outs when the lever is moved to the second position.

8. The suction mount of claim 7, wherein the first and second cut-outs each comprise an inclined surface that engages a surface of the yoke to move the yoke out of the cut-outs when the lever is moved to the second position.

9. The suction mount of claim 7, wherein movement of the yoke out of the first and second cut-outs moves a central portion of the suction cup away from a mounting surface to generate a vacuum therebetween.

10. A suction mount system comprising:
a housing;
a suction cup positioned at one side of the housing;
a lever mechanically coupled to the suction cup and positioned at least in part within the housing; and
a sleeve couplable to the lever,
wherein movement of the lever from an unactuated position to an actuated position draws a central portion of the suction cup away from a mounting surface to generate a vacuum, and
wherein coupling the sleeve to the lever prevents the lever from moving away from the actuated position.

11. The suction mount system of claim 10, wherein the sleeve includes a flange that engages the housing when coupled to the lever to rigidly fix the sleeve and the lever relative to the housing.

12. The suction mount system of claim 10, wherein the sleeve forms a hook for hanging items.

13. The suction mount system of claim 10, wherein the lever includes a lever arm comprising external threading that engages internal threading in a cavity of the sleeve to couple the sleeve to the lever.

14. The suction mount system of claim 10, wherein the lever includes a lever arm that extends at least partially out of the housing, wherein in the unactuated position the lever arm is angled with respect to a central longitudinal axis of the housing and in the actuated position the lever arm is aligned with the central longitudinal axis.

15. The suction mount system of claim 10, wherein the lever includes a first flange and a second flange that are received in respective first and second cut-outs of the housing in the unactuated position of the lever and are moved out of the first and second cut-outs when the lever is moved to the actuated position.

16. The suction mount system of claim 15, wherein the first and second cut-outs each comprise an inclined surface that engages a surface of a respective flange of the first and second flanges to draw the respective flange out of the respective cut-out when the lever is moved to the second position.

17. A method of mounting a suction mount, comprising:
positioning a base assembly of the suction mount against a mounting surface, the base assembly including a housing, a suction cup coupled to one side of the housing, and a lever mechanically coupled to the suction cup and positioned at least in part within the housing;
pivoting the lever from a first position corresponding to an unactuated state of the suction cup where the suction mount is not attached to the mounting surface and a second position that results in an actuated state of the suction cup where the suction mount is attached to the mounting surface, and
locking the lever in the second position by coupling a lock body to the lever.

18. The method of claim 17, wherein the lever comprises first threading that engages second threading of the lock body to couple the lock body to the lever.

19. The method of claim 17, wherein the lock body comprises a flat flange extending radially from an end of the lock body, and the flat flange is sized and positioned to engage a flat surface of the housing when the lock body is coupled to the lever to rigidly fix the lock body with respect to the housing and lock the lever in the second position.

20. The method of claim 17, wherein the lever includes a lever arm that extends at least partially out of the housing, wherein in the first position the lever arm is angled with respect to a central longitudinal axis of the suction mount and in the second position the lever arm is aligned with the central longitudinal axis.
